(19) United States
(12) Patent Application Publication
(10) Pub. No.: US 2008/0142014 A1
(43) Pub. Date: Jun. 19, 2008

(54) METHOD AND DEVICE FOR IMPROVING EFFICIENCY OF BREATHING

(76) Inventor: Yandong Jiang, North Reading, MA (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/611,907

(22) Filed: Dec. 18, 2006

(51) Int. Cl. A62B 18/10

(52) U.S. Cl. 128/206.24; 128/207.12

(57) ABSTRACT

A system for treating respiratory disease, obstructive sleep apnea (OSA) and snoring and for improving breathing efficiency is described. In one embodiment, the system includes a valve system having a first valve adapted to be positioned over a person's mouth and a second valve adapted to be positioned over a person's nose. The valves are selected such that in one application the valve system allows the person to inhale through the nose only and exhale through the mouth only while in another application the valve system allows the person to exhale through the nose only and inhale through the mouth only.

### CROSS-REFERENCE TO RELATED APPLICATIONS

Not applicable.

### FIELD OF THE INVENTION

This invention relates generally to methods and devices for treating respiratory disease and more particularly to methods and devices for improving efficiency of breathing.

### BACKGROUND OF THE INVENTION

As is known in the art, pursed lip breathing is a well known phenomena in people who have respiratory disease including chronic obstructive pulmonary disease (COPD) and asthma. It has been believed, but never proven, that exhalation through mouth with closed lips generates positive end expiratory pressure and thus prevents small airways from collapse in patients.

### SUMMARY OF THE INVENTION

In accordance with the present invention, a system for improving a person's breathing efficiency includes a first valve adapted to be disposed over a person's mouth and a second valve adapted to be disposed over a person's nose. The valves are selected such that the patient is allowed to inhale through their nose only and to exhale through their mouth only. With this particular arrangement, a device for treating respiratory disease is provided.

In one embodiment the valves are provided as one-way valves. One of the valves is disposed in a nasal piece and the other valve is disposed in an oral piece. During an inspiratory phase, the one-way valve in the nasal piece is open and the one-way valve in the oral piece is closed. During the expiratory phase, the one-way valve in the oral piece is open and the one-way in the nasal piece is closed. In this manner, the person is allowed to inhale through their nose only and exhale through their mouth only. This results in a reduction of dead space typically of about 100 cubic centimeters (cc) per breath and in breathing workload. It has been discovered in this invention that the benefit of pursed lip breathing may be mainly due to the reduction of dead space ventilation, and of work of breathing and improvement in the efficiency of the patient's breathing.

In another embodiment, the values are coupled to a mask adapted to be worn over a person's face. When the mask is disposed over a person's face, the first valve is disposed proximate the person's mouth and the second valve is disposed proximate the person's nose. In some embodiments, the valves are selected such that the patient is allowed to inhale through their nose only and to exhale through their mouth. In other embodiments, the valves are selected such that the patient is allowed to exhale through their nose only and to inhale through their mouth. The particular types and combinations of valves to use is selected in accordance with a variety of factors including the particular application (e.g. treatment of snoring, treatment of obstructive sleep apnea, etc. . . ) in which the mask will be used.

This breathing technique and system may be used to treat patients with lung diseases. The system and technique can also be used to treat obstructive sleep apnea (OSA). The patient with OSA will be allowed to inhale through the nose only and exhale through the mouth only. When the patient exhales through the mouth, the out flow will push the tongue forward and release the upper airway obstruction. At the end of the exhalation, the one-way valve disposed proximate the mouth (e.g. an oral piece) will be closed and forms a close compartment in the mouth. Due to the closed compartment, negative pressure in the oral cavity in front of the tongue is generated and the further failing of the tongue towards to the posterior pharyngeal wall will be prevented by the negative pressure generated in the oral cavity. Thus, the severity of upper airway obstruction will be reduced or in some case, may even be prevented entirely.

In accordance with a further aspect of the present invention, a system for improving a persons breathing efficiency includes a first valve adapted to be disposed over a person's mouth and a second valve adapted to be disposed over a person's nose. The valves are selected such that the patient is allowed to inhale through their mouth only and to exhale through their nose only. With this particular arrangement, a device for treating respiratory disease is provided.

In general, the system and related method described herein improve efficiency of breathing by inspiration through only nose and expiration through only the mouth. Alternatively, the system and related method described herein provides the same or a similar result by allowing inspiration through only mouth and expiration through only the nose. Breathing through the system reduces anatomic dead space, improves alveolar ventilation and reduces the work load of breathing.

The device of the present invention can be used in combination with non-invasive positive pressure ventilation. Normally the facemask used in non-invasive positive pressure ventilation adds another 150 cc of dead space. This results in 300 cc of the total anatomic dead space (150 cc from the natural airway and 150 cc from the facemask). The device of the present invention can reduce the anatomic dead space to 75 cc just as it does in spontaneous breathing without non-invasive positive pressure ventilation. The combination of the non-invasive positive pressure ventilation and the masks described herein may help optimize the benefit of non-invasive positive pressure ventilation by reduction of minute ventilation, airway pressure and/or tidal volume and/or the rate of ventilation.

### BRIEF DESCRIPTION OF THE DRAWINGS

The foregoing features of this invention, as well as the invention itself, may be more fully understood from the following description of the drawings in which:

FIG. 1 is an illustration of a double-one-way valve system;

FIG. 2 is a plot of breathing frequency vs. minute alveolar ventilation;

FIG. 3 is a side view of a human head illustrating dead space reduction with breathing through the device; and

FIG. 4 is a plot of breathing frequency vs. minute alveolar ventilation.

It should be understood that in an effort to promote clarity in the drawings and the text, the drawings are not necessarily to scale, emphasis instead is generally placed upon illustrating the principles of the invention.

### DESCRIPTION OF THE PREFERRED EMBODIMENTS

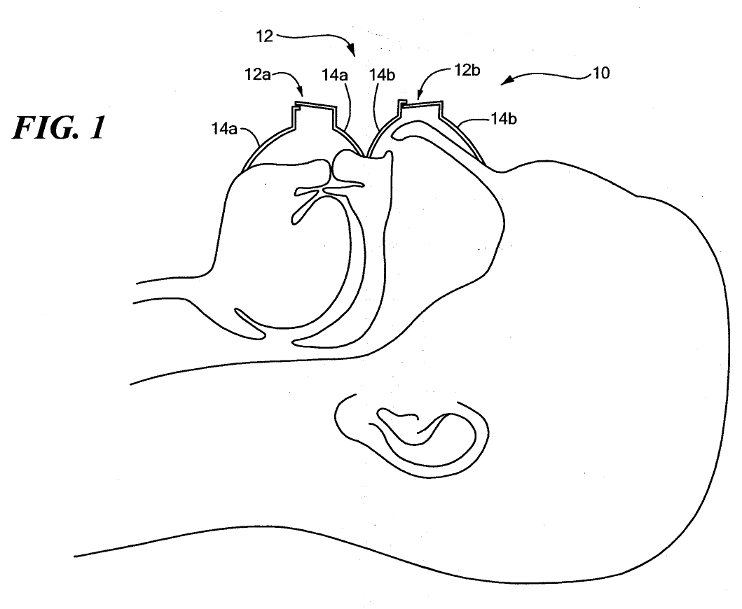

Referring now to FIG. 1, a system 10 for treating respiratory disease and more particularly for improving breathing efficiency includes a double-one-way valve system 12 having a first valve 12a adapted to be positioned over a person's mouth and a second valve 12b adapted to be positioned over a person's nose. The valves are preferably provided as low pressure values (e.g. the valves open and close as appropriate in response to relatively small pressure values). The valves 12a, 12b are disposed on respective ones of masks 14a, 14b. The masks 14a, 14b may be provided from separate pieces or as a single unitary piece. In the case where the masks 14a, 14b are provided as separate pieces (e.g. two separate pieces), they can be removably coupled together.

Also, in some embodiments, the valves may be provided as elements which are separate from the mask. Thus, in this case, the valves could be coupled to the mask (either removably coupled or fixed to the mask or permanently coupled or fixed to the mask). In other embodiments, the mask (or mask portions) may be formed with the valves therein.

In one embodiment, during inspiratory phase, the one-way valve 12a in the oral piece (e.g. mask portion 14a) is closed (i.e. air cannot pass through the valve) and the one-way valve 12b in the nasal piece (e.g. mask portion 14b) is open (i.e. air can pass through the valve). During the expiratory phase, on the other hand, the one-way valve 12a in the oral piece is open and the one-way 12b in the nasal piece is closed. Thus, the system 10 allows the person to inhale through the nose only and exhale through the mouth only.

When the patient exhales through the mouth, the out flow of gas will push the tongue forwards and release the upper airway obstruction. At the end of the exhalation, the one-way valve in the oral piece will be closed and forms a close compartment in the mouth. Due the closed compartment, negative pressure in the oral cavity in front of the tongue is generated and the further falling of the tongue towards to the posterior pharyngeal wall will be prevented by the negative pressure generated in the oral cavity. Thus, the severity of upper airway obstruction will be reduced.

The system may thus be used for treating respiratory disease and more particularly for improving efficiency of breathing. This device may also be used to treat obstructive sleep apnea (OSA) as well as snoring.

It should be appreciated that in one embodiment, one may use a strip (e.g. an adhesive strip) to hold the masks in place. It should also be appreciated that the masks must provide a seal in order to work. However, the seal does not have to be air-tight. If the seal is tight enough to hold a pressure of about 5 cm of water without leaking, it should be enough to allow for proper operation of the system 10. In general, the masks need only provide enough of a seal to allow the valves to open and close as desired to ensure proper operation of the system. Thus, in some applications, it may be necessary for the mask to provided a seal which is tight enough to hold a pressure of more that 5 cm of water without leaking while in other applications it may be necessary for the mask to provided a seal which is tight enough to hold a pressure of less than 5 cm of water without leaking. For example, if the system of the present invention (e.g. system 10 in FIG. 1) is used in combination with non-invasive positive pressure ventilation techniques, it may be necessary for the mask to provide a seal for pressures higher than 5 cm of water.

In one embodiment, the valves should open and close in response to a pressure of about 2 cm of water. In some applications, however, it may be necessary for the valves to be responsive to pressures of less than 2 cm of water while in other applications it may be necessary for the valves to be responsive to pressures of more than 2 cm of water. Those of ordinary skill in the art will understand how to select the appropriate level of sealing which the mask must provide as well as the appropriate pressure levels to which the valves must be responsive. Thus, there exists a wide range of mask seal pressures and valves pressures which can be selected depending upon the particular application. The specific mask seal pressures and operating characteristics of the valves selected for a particular application are selected to allow for proper operation of the system in the selected application.

In an alternate embodiment of the system 10, during inspiratory phase, the one-way valve 12a is open and the one-way valve 12b is closed. During the expiratory phase, on the other hand, the one-way valve 12a is closed and the one-way valve 12b is open. Thus, in this alternate embodiment, the system 10 allows the person to inhale through the mouth only and exhale through the nose only.

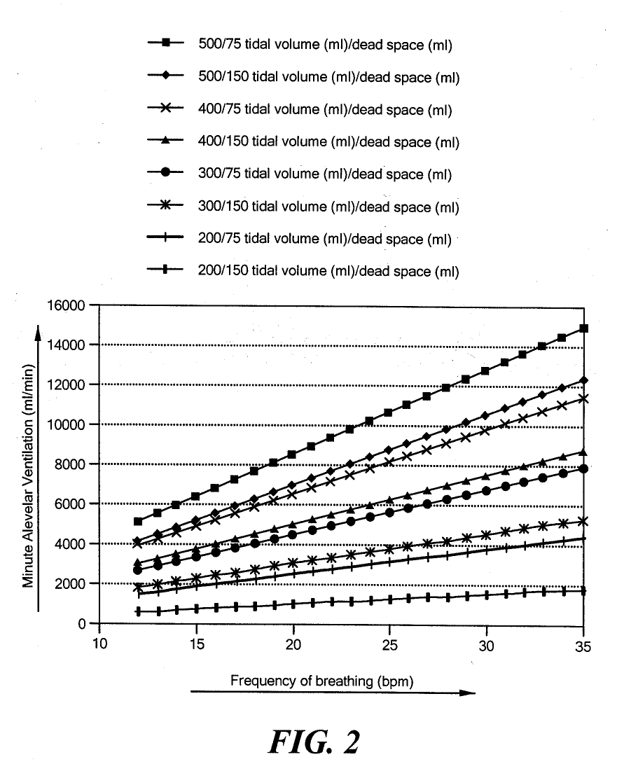

Referring now to FIG. 2, a plot of simulated effect of reduction in dead space and respiratory rate on the minute alveolar ventilation is shown. It is assumed that the anatomic dead space in a 70 kg subject is 150 milliliters (ml) and breathing through the device reduces the anatomic dead space by 50%. The mechanism of reduction in anatomic dead space by breathing through the masks is by avoiding re-breathing the expirated gas contained in the upper airway at the end of the expiration. The dead space with the device is 75 ml.

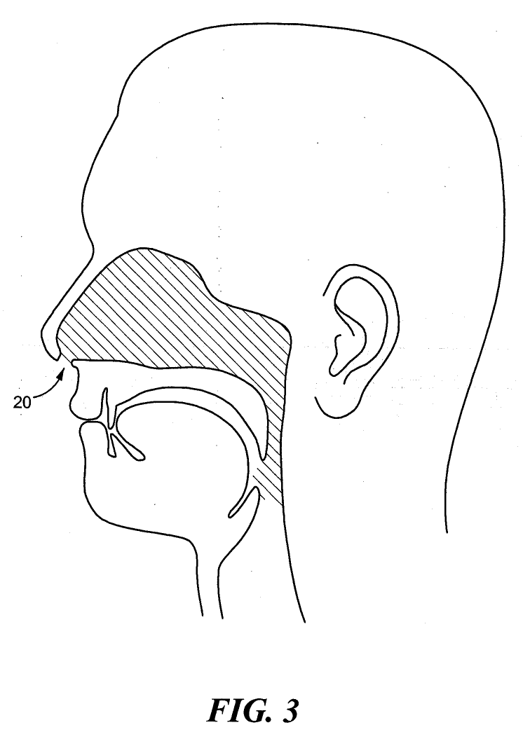

Referring now to FIG. 3, a human head illustrating dead space reduction with breathing through the device is shown. Region 20 indicated by the cross-hatching represents the dead space by-passed.

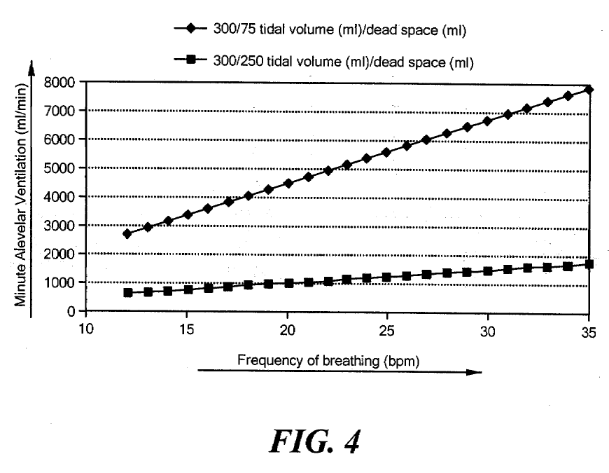

Referring now to FIG. 4, a plot of breathing frequency vs. minute alveolar ventilation is shown. The simulated effect of full facemask and the mask of the present invention (e.g. the mask of FIG. 1) on the minute alveolar ventilation are shown. It is assumed that the anatomic dead space in a 70 kilogram (kg) subject is 75 milliliters (ml) with a mask which is the same as or similar to that described above in conjunction with FIG. 1 and 250 ml with a full facemask. In both scenarios, the tidal volume of the subject is 300 ml.

All publications and references cited herein are expressly incorporated herein by reference in their entirety.

The particular combinations of elements and features in the above-detailed embodiments are exemplary only; the interchanging and substitution of these teachings with other teachings in this and the incorporated-by-reference patents and applications are also expressly contemplated. As those skilled in the art will recognize, variations, modifications, and other implementations of what is described herein can occur to those of ordinary skill in the art without departing from the spirit and the scope of the invention as claimed.

Further, in describing the invention and in illustrating embodiments of the invention in the figures, specific terminology, numbers, dimensions, materials, etc., are used only for the sake of clarity. However the invention is not limited to any specific terms, numbers, dimensions, materials, etc. so selected, and each specific term, number, dimension, material, etc., at least includes all technical and functional equivalents that operate in a similar manner to accomplish a similar purpose. Use of a given word, phrase, number, dimension, material, language terminology, product brand, etc. is intended to include all grammatical, literal, scientific, technical, and functional equivalents. The terminology used herein is for the purpose of description and not limitation.

Having described the preferred embodiments of the invention, it will now become apparent to one of ordinary skill in the art that other embodiments incorporating their concepts may be used. Moreover, those of ordinary skill in the art will appreciate that the embodiments of the invention described herein can be modified to accommodate and/or comply with changes and improvements in the applicable technology and standards referred to herein. For example, the technology can be implemented in many other, different, forms, and in many different environments, and the technology disclosed herein can be used in combination with other technologies. Variations, modifications, and other implementations of what is described herein can occur to those of ordinary skill in the art without departing from the spirit and the scope of the invention as claimed. It is felt therefore that these embodiments should not be limited to disclosed embodiments but rather should be limited only by the spirit and scope of the appended claims.

The particular combinations of elements and features in the above-detailed embodiments are exemplary only; the interchanging and substitution of these teachings with other teachings in this and the referenced patents/applications are also expressly contemplated. As those skilled in the art will recognize, variations, modifications, and other implementations of what is described herein can occur to those of ordinary skill in the art without departing from the spirit and the scope of the invention as claimed.

Accordingly, the foregoing description is by way of example only and is not intended as limiting. The invention's scope is defined in the following claims and the equivalents thereto.

What is claimed is:

1. A respiratory device comprising:
a first valve adapted to be disposed over a person's mouth; and
a second valve adapted to be disposed over a person's nose.

2. The device of claim 1 wherein said first and second valves operate such they allow a person to inhale through the nose only and exhale through the mouth only.

3. The device of claim 1 wherein said first and second valves operate such they allow a person to inhale through the mouth only and exhale through the nose only.

4. The device of claim 1 wherein the valves operate such that the first valve is open when the second valve is closed and the first valve is closed when the second valve is open.

5. The device of claim 1 further comprising a mask portion in which the first and second valves are disposed.

6. The device of claim 5 wherein said mask is adapted to provide a seal around the person's mouth and nose.

7. The device of claim 6 wherein said mask is provided from a first mask portion adapted to couple to a mouth region of a person and a second mask portion adapted to couple to a nose region of the person.

8. The device of claim 1 further comprising:
an oral piece adapted to be coupled to a person's mouth, said first valve coupled to said oral piece; and
a nasal piece adapted to be coupled to a person's nose, said second valve coupled to said nasal piece.

9. The device of claim 1 wherein said first valve is provided as a one-way valve.

10. The device of claim 1 wherein said second valve is provided as a one-way valve.

11. The device of claim 1 wherein said first and second valves are both provided as one-way valves such that during a person's inspiratory phase, the first valve prevents the person from inhaling air through their mouth and the second valve allows the person to inhale air through their nose.

12. A system for treating respiratory disease and for improving breathing efficiency, the system comprising:
a valve system having a first valve adapted to be positioned over a person's mouth and a second valve adapted to be positioned over a person's nose such that the valve system allows the person to inhale through the nose only and exhale through the mouth only.

13. The system of claim 12 wherein said valve system is provided from a pair of one-way valves.

14. The system of claim 13 further comprising:
an oral piece having the first valve disposed therein; and
a nasal piece having the second valve disposed therein.

15. The system of claim 12 wherein during a person's inspiratory phase, the first one-way valve is closed and the second one-way valve is open and during a person's expiratory phase the first one-way valve is open and the second one-way valve is closed.

16. The system of claim 15 further comprising a mask portion in which the first and second valves are disposed.

17. The system of claim 16 wherein said mask is adapted to provide a seal around the person's mouth and nose.

18. A system for treating respiratory disease and for improving breathing efficiency, the system comprising:
a valve system having a first valve adapted to be positioned over a person's mouth and a second valve adapted to be positioned over a person's nose such that the valve system allows the person to inhale through the mouth only and exhale through the nose only.

19. The system of claim 18 wherein said valve system is provided from a pair of one-way valves.

20. The system of claim 19 further comprising:
an oral piece having the first valve disposed therein; and
a nasal piece having the second valve disposed therein.

21. A method for treating a person the method comprising:
in response to an exhalation phase of the person, opening a first valve disposed over the person's mouth and closing a second valve disposed over a person's nose such that the person is allowed to exhale only through the mouth; and
in response to an inhalation phase of the person, closing the first valve disposed over the person's mouth and opening the second valve disposed over the person's nose such that the person is allowed to only inhale through the nose.

22. The method of claim 21 wherein the valves are provided as one-way valves which open and close in response to certain valve pressures and wherein when the person exhales through the mouth, the out flow of air pushes the person's tongue forward and releases any upper airway obstruction in the person.

23. The method of claim 22 wherein at the end of the exhalation phase, the one-way valve disposed proximate the mouth will be closed and forms a close compartment in the mouth which generates negative pressure in the oral cavity in front of the tongue and which prevents the further falling of the tongue towards the posterior pharyngeal wall to reduce the severity of any upper airway obstruction.

24. The method of claim 23 wherein during a person's inspiratory phase, the first one-way valve is closed for a period of time during which the second one-way valve is open and during a person's expiratory phase the first one-way valve is open for a period of time during which the second one-way valve is closed.

25. The method of claim 24 wherein the person's breathing respectively opens and closes the valves.

26. The method of claim 25 wherein the first and second valves are disposed in a mask and the method further comprises sealing the mask around the person's mouth and nose.

27. The method of claim 26 wherein the method is used to treat obstructive sleep apnea (OSA).

28. The method of claim 26 wherein the method is used to treat snoring.
